(19) United States
(12) Patent Application Publication
(10) Pub. No.: US 2026/0269615 A1
(43) Pub. Date: Sep. 10, 2026

(54) LINEAR TIME-PERIODIC MODEL OF THREE-LEVEL INVERTER CONSIDERING NEUTRAL POINT DYNAMICS

(71) Applicants: Guangxi Power Grid Co. LTD, Guangxi (CN); HUAZHONG UNIVERSITY OF SCIENCE AND TECHNOLOGY, Hubei (CN)

(72) Inventors: Hui Qin, Guangxi (CN); Jiabing Hu, Guangxi (CN); Juan Chen, Guangxi (CN); Jiali Kui, Guangxi (CN); Ming Yu, Guangxi (CN); Yingbiao Li, Guangxi (CN); Zhen Pan, Guangxi (CN); Guojie Zhao, Guangxi (CN); Xin Lin, Guangxi (CN); Zhaolin Zhang, Guangxi (CN); Junjie Feng, Guangxi (CN); Zefei Wu, Guangxi (CN); Buyang Du, Guangxi (CN); Zeren Guo, Guangxi (CN)

(73) Assignees: Guangxi Power Grid Co. LTD, Guangxi (CN); HUAZHONG UNIVERSITY OF SCIENCE AND TECHNOLOGY, Hubei (CN)

(21) Appl. No.: 19/440,463

(22) Filed: Jan. 5, 2026

(30) Foreign Application Priority Data
Mar. 4, 2025 (CN) 202510251989.1

(51) Int. Cl. H02J 3/0014; H02J 103/30; H02M 1/00

(52) U.S. Cl. CPC H02J 3/0014; H02M 1/009; H02J 2103/30

(57) ABSTRACT

The present discloses a linear time-periodic model of a three-level inverter considering neutral point dynamics. In the present application, a piecewise linearization processing method is adopted to divide non-differentiable terms in an original nonlinear model of a three-level inverter into a plurality of linear segments, and linearization processing is carried out in each segment to eliminate the non-differentiable terms of a non-differentiable part (such as a neutral point voltage and a neutral point current) and ensure that the linear time-periodic model of a three-level inverter obtained is locally analyzable, which avoids the problem of difficulty in overall linearization. The linear time-periodic model of a three-level inverter is generated by combining with a steady-state trajectory, which can comprehensively reflect small signal characteristics of a three-level inverter. This model can be applied to small-signal stability analysis of power systems containing a three-level inverter.

### CROSS-REFERENCE TO RELATED APPLICATIONS

This application claims the priority benefit of China application serial no. 202510251989.1, filed on Mar. 4, 2025. The entirety of the above-mentioned patent application is hereby incorporated by reference herein and made a part of this specification.

### TECHNICAL FIELD

The present application relates to the technical field of power systems, and more specifically, relates to a linear time-periodic model of a three-level inverter considering neutral point dynamics.

### DESCRIPTION OF RELATED ART

Driven by the “Dual Carbon” goals, renewable energy sources such as wind power and photovoltaic power generation have been developed rapidly. With the continuous increase in the capacity of renewable energy, higher requirements are put forward for the power level of inverters. Three-level inverters are widely applied in wind and photovoltaic power generation due to the applicability to high voltage and large capacity as well as the advantages of high efficiency and low harmonic content. However, as the proportion of renewable energy in power grids continues to increase, power systems show a trend of power electronicization gradually, and stability characteristics thereof are changed. Electromagnetic oscillations occur frequently in actual systems.

A small signal model of power electronic equipment is a foundation for studying the stability of a small signal in a power system, and therefore, establishing an accurate small signal model is of great significance for the research of system stability mechanisms. At present, for small signal modeling of a three-level grid-connected inverter in renewable energy, a two-level model is generally adopted as equivalent, and no relevant research on small signal models of three-level inverters considering neutral point dynamics has been conducted, which cannot accurately reflect internal characteristics of a three-level inverter, resulting in potential oscillation modes being unidentifiable and making stability analysis of a power system not comprehensive enough.

### SUMMARY

In view of defects in the prior art, the purpose of the present application is to provide a linear time-periodic model of a three-level inverter considering neutral point dynamics, aiming to solve the problem in the prior art that a two-level fan model is adopted as equivalent, which cannot accurately reflect internal characteristics of a three-level inverter, resulting in some oscillation modes being unidentifiable and making stability analysis of a power system not comprehensive enough.

To achieve the above purpose, in first aspect, the present application provides a linear time-periodic model of a three-level inverter considering neutral point dynamics, comprising:
A construction module, configured to construct an original nonlinear model of a three-level inverter considering neutral point dynamics;
A first processing module, configured to perform piecewise processing on non-differentiable terms in the original nonlinear model of a three-level inverter to obtain a nonlinear model of a three-level inverter;
A second processing module, configured to perform piecewise linearization processing on the nonlinear model of a three-level inverter to obtain the linear time-periodic model of a three-level inverter considering neutral point dynamics.

In some embodiments, the original nonlinear model of a three-level inverter comprises:
An external circuit dynamic module, a power outer loop controller, a current inner loop controller, a phase-locked loop controller, an internal circuit dynamic module and a neutral point potential balance controller;
The external circuit dynamic module is configured to send an output current and a grid interconnection voltage of a three-level inverter to the phase-locked loop controller, the power outer loop controller and the current inner loop controller, and send the output current, a power factor angle and an amplitude of the output current to the internal circuit dynamic module;
The phase-locked loop controller is configured to determine a phase-locked angle based on the output current and the grid interconnection voltage, and send the phase-locked angle to the internal circuit dynamic module, the current inner loop controller and the power outer loop controller respectively;
The power outer loop controller is configured to generate a reference current based on the phase-locked angle, the grid interconnection voltage and the output current, and send the reference current to the current inner loop controller;
The current inner loop controller is configured to generate a modulated wave based on the phase-locked angle, the reference current and the output current, and send the modulated wave to the internal circuit dynamic module;
The internal circuit dynamic module is configured to determine a neutral point current of the three-level inverter and a neutral point voltage of the three-level inverter based on an output value of the neutral point potential balance controller, the phase-locked angle, the output current and the modulated wave;
The neutral point potential balance controller is configured to determine the output value based on the neutral point voltage.

In some embodiments, the first processing module is also configured to:
Perform piecewise processing on non-differentiable terms in the neutral point current and the neutral point voltage to obtain the nonlinear model of a three-level inverter.

In some embodiments, the neutral point potential balance controller adopts a proportional-integral controller.

In some embodiments, the second processing module is further configured to:
Determine a steady-state trajectory of the nonlinear model of a three-level inverter when operating to a steady-state condition.

In some embodiments, the three-level inverter is a neutral point clamped three-level inverter or a T-type three-level inverter.

In a second aspect, the present application provides a method for constructing the linear time-periodic model of a three-level inverter considering neutral point dynamics, comprising:
Constructing an original nonlinear model of a three-level inverter considering neutral point dynamics;
Performing piecewise processing on non-differentiable terms in the original nonlinear model of a three-level inverter to obtain a nonlinear model of a three-level inverter;
Performing piecewise linearization processing on the nonlinear model of a three-level inverter to obtain the linear time-periodic model of a three-level inverter considering neutral point dynamics.

In a third aspect, the present application provides an electronic device, comprising: at least one memory, configured to store programs; and at least one processor, configured to execute programs stored in the memory, and configured to implement the method described in the first aspect or any embodiment of the first aspect when the programs stored in the memory are executed.

In a fourth aspect, the present application provides a computer readable storage medium storing computer programs which, when executed on a processor, make the processor execute the method described in the first aspect or any embodiment of the first aspect.

In a fifth aspect, the present application provides a computer program product which, when executed on a processor, makes the processor execute the method described in the first aspect or any embodiment of the first aspect.

In general, the above technical solutions conceived by the present application have the following beneficial effects compared with the prior art:

In the linear time-periodic model of a three-level inverter considering neutral point dynamics provided by the present application, a piecewise linearization processing method is adopted to divide non-differentiable terms in an original nonlinear model of a three-level inverter into a plurality of linear segments, and linearization processing is carried out in each segment to eliminate the non-differentiable terms of a non-differentiable part (such as a neutral point voltage and a neutral point current) and ensure that the linear time-periodic model of a three-level inverter obtained is locally analyzable, which avoids the problem of difficulty in overall linearization. The linear time-periodic model of a three-level inverter is generated by combining with a steady-state trajectory, which can comprehensively reflect small signal characteristics of a three-level inverter. In particular, the model generated can precisely describe dynamic characteristics of a neutral point of the three-level inverter under a small signal, effectively depict behaviors of the three-level inverter under minor disturbances, and can be applied to small signal stability analysis of a power system containing the three-level inverter.

### BRIEF DESCRIPTION OF THE DRAWINGS

FIG. 1 is a structural schematic diagram of a linear time-periodic model of a three-level inverter considering neutral point dynamics provided by embodiments of the present application;

FIG. 2 is another structural schematic diagram of a linear time-periodic model of a three-level inverter considering neutral point dynamics provided by embodiments of the present application;

FIG. 3 is a comparison diagram of time-domain responses of neutral point dynamics under a small signal between a linear time-periodic model of a three-level inverter provided by embodiments of the present application and an original nonlinear model of a three-level inverter;

FIG. 4 is a flow chart of a method for constructing a linear time-periodic model of a three-level inverter considering neutral point dynamics provided by embodiments of the present application;

FIG. 5 is a structural schematic diagram of an electronic device provided by embodiments of the present application.

### DESCRIPTION OF THE EMBODIMENTS

To make the purpose, the technical solution and the advantages of the present application more clear, the present application is further described below in detail in combination with the drawings and the embodiments. It should be understood that specific embodiments described herein are only used for explaining the present application, not used for limiting the present application.

The term “and/or” herein is an association relationship describing association objects, indicating that three relationships can exist, for example, A and/or B can represent three conditions: A exists alone, both A and B exist simultaneously, and B exists alone. The symbol “/” herein represents that association objects have an “or” relationship, for example, A/B represents A or B.

The terms such as “first” and “second” in the description and claims herein are used for distinguishing different objects, rather than used for describing the specific sequence of the objects. For example, a first processing module, a second processing module, etc. are used for distinguishing different processing modules, rather than used for describing the specific sequence of the processing modules.

In the embodiments of the present application, the words such as “exemplary” or “for example” are used to indicate taking an example, illustration or explanation. Any embodiment or design solution described as “exemplary” or “for example” in the embodiments of the present application shall not be interpreted to be more preferable or superior to other embodiments or design solutions. Exactly, the words such as “exemplary” or “for example” are intended to present related concepts in a concrete way.

In the description of the embodiments of the present application, the meaning of “a plurality of” is two or more unless otherwise specified.

The embodiments of the present application are described below in combination with the drawings in the embodiments of the present application.

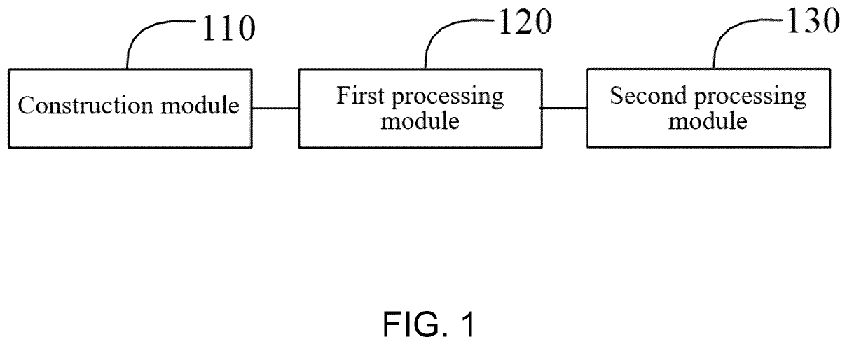

Referring to FIG. 1, the embodiments of the present application provide a linear time-periodic model of a three-level inverter considering neutral point dynamics, comprising: a construction module 110, a first processing module 120 and a second processing module 130.

The construction module 110 is configured to construct an original nonlinear model of a three-level inverter considering neutral point dynamics;
The first processing module 120 is configured to perform piecewise processing on non-differentiable terms in the original nonlinear model of a three-level inverter to obtain a nonlinear model of a three-level inverter;
The second processing module 130 is configured to perform piecewise linearization processing on the nonlinear model of a three-level inverter to obtain the linear time-periodic model of a three-level inverter considering neutral point dynamics.

In the embodiments of the present application, the linear time-periodic model of a three-level inverter may specifically comprise the construction module 110, the first processing module 120 and the second processing module 130.

Neutral point dynamic balance of a three-level inverter is a key issue during the operation of the three-level inverter, which directly affects output voltage quality, device stress and system reliability. Based on this, in the embodiments of the present application, the original nonlinear model corresponding to a three-level inverter considering neutral point dynamics (i.e., the original nonlinear model of a three-level inverter) is established by the construction module 110.

Further, in some embodiments, the three-level inverter is a neutral point clamped three-level inverter or a T-type three-level inverter.

In the embodiments of the present application, the three-level inverter may adopt a neutral point clamped three-level inverter or a T-type three-level inverter.

In addition, as a neutral point current is affected by a switching device control logic, non-differentiable points exist in a power system, which makes the linearization processing of the original nonlinear model of a three-level inverter considering neutral point dynamics difficult. Moreover, a neutral point potential of the three-level inverter shows a time-varying characteristic of three-octave-band pulsation in a steady-state condition, which also puts forward a requirement for a small signal model of the three-level inverter.

Based on this, in the embodiments of the present application, the piecewise processing is performed on the non-differentiable terms in the original nonlinear model of a three-level inverter established above by combining with the first processing module 120, thereby constructing a nonlinear model of a three-level inverter.

The linearization processing is performed on the nonlinear model of a three-level inverter obtained above by combining with the second processing module 130 to obtain the linear time-periodic model of a three-level inverter considering neutral point dynamics.

In the linear time-periodic model of a three-level inverter considering neutral point dynamics provided by the embodiments of the present application, a piecewise linearization processing method is adopted to divide non-differentiable terms in an original nonlinear model of a three-level inverter into a plurality of linear segments, and linearization processing is carried out in each segment to eliminate the non-differentiable terms of a non-differentiable part (such as a neutral point voltage and a neutral point current) and ensure that the linear time-periodic model of a three-level inverter obtained is locally analyzable, which avoids the problem of difficulty in overall linearization. The linear time-periodic model of a three-level inverter is generated by combining with a steady-state trajectory, which can comprehensively reflect small signal characteristics of a three-level inverter. In particular, the model generated can precisely describe dynamic characteristics of a neutral point of the three-level inverter under a small signal, effectively depict behaviors of the three-level inverter under minor disturbances, and can be applied to small signal stability analysis of a power system containing the three-level inverter.

Further, in some embodiments, the original nonlinear model of a three-level inverter comprises:
An external circuit dynamic module, a power outer loop controller, a current inner loop controller, a phase-locked loop controller, an internal circuit dynamic module and a neutral point potential balance controller;
The external circuit dynamic module is configured to send an output current and a grid interconnection voltage of a three-level inverter to the phase-locked loop controller, the power outer loop controller and the current inner loop controller, and sending the output current, a power factor angle and an amplitude of the output current to the internal circuit dynamic module;
The phase-locked loop controller is configured to determine a phase-locked angle based on the output current and the grid interconnection voltage, and sending the phase-locked angle to the internal circuit dynamic module, the current inner loop controller and the power outer loop controller respectively;
The power outer loop controller is configured to generate a reference current based on the phase-locked angle, the grid interconnection voltage and the output current, and sending the reference current to the current inner loop controller;
The current inner loop controller is configured to generate a modulated wave based on the phase-locked angle, the reference current and the output current, and sending the modulated wave to the internal circuit dynamic module;
The internal circuit dynamic module is configured to determine a neutral point current and a neutral point voltage of the three-level inverter based on an output value of the neutral point potential balance controller, the phase-locked angle, the output current and the modulated wave;
The neutral point potential balance controller is configured to determine the output value based on the neutral point voltage.

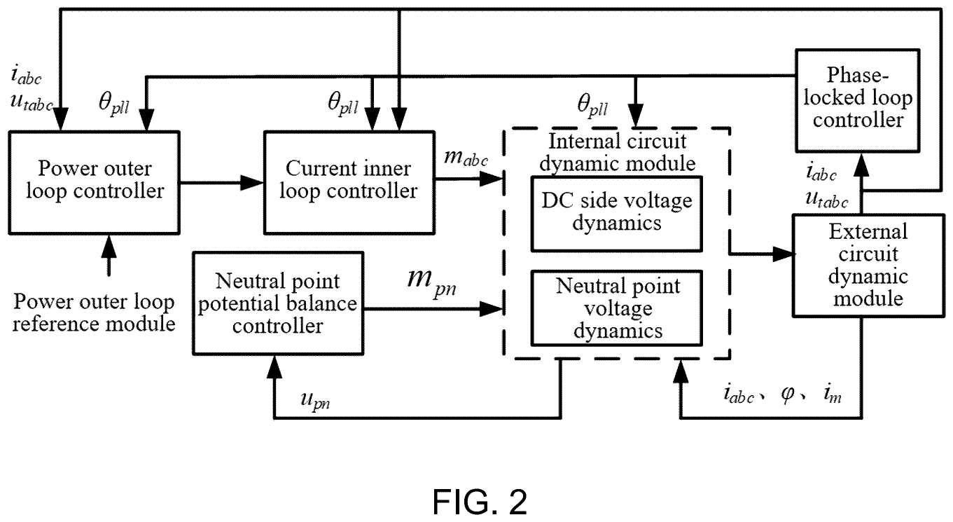

In the embodiments of the present application, the original nonlinear model of a three-level inverter constructed may comprise an external circuit dynamic module, a power outer loop controller, a current inner loop controller, a phase-locked loop controller, an internal circuit dynamic module, a neutral point potential balance controller, etc., as shown in FIG. 2 specifically.

A process that physical quantities such as an output current i_{abc}, an internal potential u_{abc} and a grid interconnection voltage u_{tabc} of the three-level inverter change over time is reflected by the external circuit dynamic module. Specifically, the external circuit dynamic module is configured to send the output current abc and the grid interconnection voltage u_{tabc} of the three-level inverter to the phase-locked loop controller, the power outer loop controller and the current inner loop controller, and sending the output current i_{abc}, a power factor angle and an amplitude of the output current i_{abc} to the internal circuit dynamic module. The power outer loop controller is configured to generate a reference current based on a phase-locked angle θₚₗₗ, the grid interconnection voltage u_{tabc} and the output current i_{abc}, and sending the reference current to the current inner loop controller, thus enabling the current inner loop controller to generate a modulated wave m_{abc} based on the reference current, the phase-locked angle θₚₗₗ and the output current i_{abc}. Specifically, the power outer loop controller is configured to perform Park transformation on the grid interconnection voltage and the output current to obtain the reference current. The phase-locked loop controller is configured to send the phase-locked angle θₚₗₗ to the internal circuit dynamic module, the current inner loop controller and the power outer loop controller based on the output current i_{abc} and the grid interconnection voltage u_{tabc}, thus to achieve the Park transformation between a three-phase coordinate system and a rotating coordinate system. A power outer loop reference module is configured to output reference values of an active power output and a reactive power output of the three-level inverter. In the embodiments of the present application, the modulated wave m_{abc} is an a, b, c three-phase modulated wave, the output current i_{abc} comprises an a, b, c three-phase output current iⱼ, and j=a, b, c.

The internal circuit dynamic module may be configured to determine a neutral point current iₚₙ and a neutral point voltage uₚₙ of the three-level inverter based on an output value mₚₙ of the neutral point potential balance controller, the phase-locked angle θₚₗₗ, the output current i_{abc} and the modulated wave m_{abc}

Specifically, the internal circuit dynamic module comprises DC side voltage dynamics and neutral point voltage dynamics, and the neutral point current iₚₙ of the three-level inverter can be expressed as:

$${i}_{pn} = {\sum }_{j = a , b , c} ( 1 - \vert {m}_{j} \vert ) {i}_{j} - 6 / π m {}_{pn} {i}_{m} cos φ$$

where the absolute value |mⱼ| of the three-phase modulated wave is a continuous non-differentiable term, iₘ is the amplitude of the output current iabc, and φ is the power factor angle, which can be obtained by measurement.

An expression of the neutral point voltage uₚₙ is:

$${\dot{u}}_{pn} = \frac{\text{?}}{{C}_{p} + {C}_{n}}$$

$$\text{?} \text{indicates text missing or illegible when filed}$$

where represents a derivative of the neutral point voltage uₚₙ (a voltage difference between two capacitors), and Cₚ and Cₙ are capacitance values of the two capacitors connected in series on a DC side.

The neutral point potential balance controller is configured to determine the output value mₚₙ based on the neutral point voltage uₚₙ, and the output value mₚₙ is a three-phase modulated wave.

Further, in some embodiments, the neutral point potential balance controller adopts a proportional-integral controller.

In the embodiments of the present application, the neutral point potential balance controller may adopt a proportional-integral controller.

The above neutral point potential balance controller is specifically configured to balance the neutral point voltage uₚₙ, which can be expressed as:

$$\{ \begin{matrix}{\dot{x}}_{v} = {k}_{ppn} ( 0 - {u}_{pn} ) \\ {m}_{pn} = \frac{( \text{?} ( 0 - {u}_{pn} ) + {x}_{v} )}{\text{?}}\end{matrix}$$

$$\text{?} \text{indicates text missing or illegible when filed}$$

where kₚₚₙ is a proportional gain coefficient of the neutral point potential balance controller (i.e., the proportional-integral controller), kᵢₚₙ is an integral regulation coefficient of the neutral point potential balance controller, \dot{x}ᵥ is an output of a proportional link, xᵥ is an input of an integral link, and u_{dc} is a voltage on the DC side of the three-level inverter.

The above formulas jointly constitute the original nonlinear model of a three-level inverter in the embodiments of the present application.

Further, in some embodiments, the first processing module 120 is also configured to:

Perform piecewise linearization processing on non-differentiable terms in the neutral point current and the neutral point voltage to obtain the nonlinear model of a three-level inverter.

In the embodiments of the present application, after the above original nonlinear model of a three-level inverter is obtained, piecewise processing is performed on the non-differentiable terms in the original nonlinear model of a three-level inverter, then:

$$\vert \text{?} \vert = sgn ( {m}_{j} ) = \{ \begin{matrix}{m}_{j} , {m}_{j} > 0 \\ - {m}_{j} , {m}_{j} < 0 \\ 0 , \text{?} = 0\end{matrix}$$

$$\text{?} \text{indicates text missing or illegible when filed}$$

where sgn(mⱼ) is a value obtained after piecewise linearization processing is performed on the non-differentiable term |mⱼ|.

The main features of performing piecewise processing on non-differentiable terms in the neutral point current and the neutral point voltage to obtain the nonlinear model of a three-level inverter comprise:

$$\{ \begin{matrix}{\dot{u}}_{pn} = \frac{{i}_{pn}}{{C}_{p} + {C}_{n}} \\ {\dot{x}}_{v} = {k}_{ppn} ( 0 - {u}_{pn} ) \\ {m}_{pn} = \frac{( \text{?} ( 0 - {u}_{pn} ) + {x}_{v} )}{{u}_{dc}} \\ {i}_{pn} = \text{?} ( 1 - sgn ( \text{?} ) ) {i}_{j} - 6 / π m {}_{pn} {i}_{m} cos φ\end{matrix}$$

$$\text{?} \text{indicates text missing or illegible when filed}$$

Further, in some embodiments, the second processing module 130 is also configured to:

Determine a steady-state trajectory of the nonlinear model of a three-level inverter when operating to a steady-state condition.

In the embodiments of the present application, the nonlinear model of a three-level inverter constructed is operated by the second processing module 130 to the steady-state condition to obtain a steady-state trajectory x₀, x represents each variable, and the subscript “0” represents a corresponding steady-state trajectory.

The following processing method is adopted to perform piecewise linearization processing on the nonlinear model of a three-level inverter:

Trajectory linearization is performed on iₚₙ near the zero point, then:

$$Δ {i}_{pn} = \text{?} [ - Δ sgn ( {m}_{j} ) {i}_{j 0} + ( 1 - {sgn ( {m}_{j} )}_{0} ) Δ {i}_{j} ] - 6 / π ( \text{?} cos {φ}_{0} Δ {m}_{pn} + \text{?} cos {φ}_{0} Δ {i}_{m} + \text{?} sin Δ φ$$

$$\text{?} \text{indicates text missing or illegible when filed}$$

where “Δ” represents a small signal perturbation of each variable, Δiⱼ represents a steady-state trajectory of iⱼ, Δiₚₙ represents a small signal perturbation of iₚₙ, Δsgn(mⱼ) represents a small signal perturbation of sgn(mⱼ), iⱼ₀ represents a steady-state trajectory of iⱼ, Δiₘ represents a small signal perturbation of iₘ, iₘ₀ represents a steady-state trajectory of iₘ, Δφ represents a small signal perturbation of φ, sgn(mⱼ)₀ represents a steady-state trajectory of sgn(mⱼ), and mₚₙ₀ represents a steady-state trajectory of mₚₙ.

Piecewise linearization processing is performed on sgn(mⱼ). Since Δsgn(mⱼ) undergoes a discontinuity around zero, Δsgn(mⱼ) is smoothed at the zero-crossing by approximating sgn(mⱼ) as tanh(k_{sgn}mⱼ), where the smoothing coefficient k_{sgn} is chosen greater than 10². Therefore, the linearization of the zero-crossing point of sgn(mⱼ) is achieved through the following formula:

$$Δ sgn ( {m}_{j} ) = \{ \begin{matrix}0 , {m}_{j 0} + Δ {m}_{j} > 0 \\ {k}_{sgn} {sech}^{2} ( 0 ) Δ {m}_{j} , {m}_{j 0} + Δ {m}_{j} = 0 \\ 0 , {m}_{j 0} + Δ {m}_{j} < 0\end{matrix}$$

where Δmⱼ is a small signal perturbation of mⱼ, and mⱼ₀ is a steady-state trajectory of mⱼ.

The main features of the linear time-periodic model of a three-level inverter established comprise:

$$\{ \begin{matrix}Δ {\dot{u}}_{pn} = \frac{{i}_{pn}}{{C}_{p} + {C}_{n}} \\ Δ {\dot{x}}_{v} = {k}_{ppn} ( 0 - Δ {u}_{pn} ) \\ Δ {m}_{pn} = \frac{( \text{?} ( 0 - Δ {u}_{pn} ) + Δ {x}_{v} )}{{u}_{dc}} \\ \begin{matrix}Δ {i}_{pn} = \text{?} [ - Δ sgn ( {m}_{j} ) \text{?} + ( 1 - {sgn ( {m}_{j} )}_{0} ) Δ {i}_{j} ] - \\ 6 / π ( {i}_{m 0} cos {φ}_{0} Δ {m}_{pn} + {m}_{pn 0} cos {φ}_{0} Δ {i}_{m} + {m}_{pn} \text{?} sin Δ φ\end{matrix} \\ Δ sgn ( {m}_{j} ) = \{ \begin{matrix}0 , \text{?} + Δ {m}_{j} > 0 \\ {k}_{sgn} {sech}^{2} ( 0 ) Δ {m}_{j} , {m}_{j 0} + Δ {m}_{j} = 0 \\ 0 , {m}_{j 0} + Δ {m}_{j} < 0\end{matrix}\end{matrix}$$

$$\text{?} \text{indicates text missing or illegible when filed}$$

where “Δ” represents a small signal perturbation of each variable, and Δ\dot{u}ₚₙ represents a small signal perturbation of \dot{u}ₚₙ.

In specific implementation, after the original nonlinear model of a three-level inverter is obtained, a three-phase grid voltage balanced power system is considered in the present embodiment, and mⱼ can be expressed as:

$$\{ \begin{matrix}\text{?} = m cos ( θ - φ ) \\ \text{?} = m cos ( θ - φ - 2 π / 3 ) \\ \text{?} = m cos ( θ - φ \text{?} 2 π / 3 ) \\ θ = \text{?} + \text{?}\end{matrix}$$

$$\text{?} \text{indicates text missing or illegible when filed}$$

Since the period of |cos(θ−φ)| is π and the period of cos θ is π/n, for the integral between [−π,π], due to the periodicity, zero-crossing points of |cos(θ−φ)| within the integral range are (−π/2+φ−θ) and (π/2+φ−θ). Piecewise linearization processing is performed on sgn(mⱼ) then:

$$\{ \begin{matrix}Δ sgn ( {m}_{a} ) = \{ \begin{matrix}0 , {m}_{a 0} + Δ {m}_{j} > 0 \\ {k}_{sgn} {sech}^{2} ( 0 ) Δ {m}_{a} , {m}_{a 0} + Δ {m}_{a} = 0 \\ 0 , {m}_{a 0} + Δ {m}_{j} < 0\end{matrix} \\ Δ sgn ( {m}_{b} ) = \{ \begin{matrix}0 , {m}_{b 0} + Δ {m}_{b} > 0 \\ {k}_{sgn} {sech}^{2} ( 0 ) Δ {m}_{b} , {m}_{b 0} + Δ {m}_{b} = 0 \\ 0 , {m}_{b 0} + Δ {m}_{b} < 0\end{matrix} \\ Δ sgn ( {m}_{b} ) = \{ \begin{matrix}0 , {m}_{c 0} + Δ {m}_{c} > 0 \\ {k}_{sgn} {sech}^{2} ( 0 ) Δ {m}_{c} , {m}_{c 0} + Δ {m}_{c} = 0 \\ 0 , {m}_{c 0} + Δ {m}_{c} < 0\end{matrix} \\ Δ {m}_{a} = - Δ m cos ( {θ}_{0} - {φ}_{0} ) + {m}_{0} cos ( {θ}_{0} - {φ}_{0} ) ( Δ θ - Δφ ) \\ Δ {m}_{b} = - Δ m cos ( {θ}_{0} - {φ}_{0} - 2 π / 3 ) + {m}_{0} cos ( {θ}_{0} - {φ}_{0} - 2 π / 3 ) ( Δθ - Δφ ) \\ Δ {m}_{c} = - Δ m cos ( {θ}_{0} - {φ}_{0} + 2 π / 3 ) + {m}_{0} cos ( {θ}_{0} - {φ}_{0} + 2 π / 3 ) ( Δθ - Δφ )\end{matrix}$$

where Δsgn(mₐ), Δsgn(m_{b}) and Δsgn(m_{b}) are values obtained after piecewise linearization processing is performed on sgn(mⱼ) (j=a, b, c), Δm is a small signal perturbation of an amplitude m of the modulated wave m_{abc}, θ₀ is a steady-state trajectory of θ, φ₀ is a steady-state trajectory of φ, m₀ is a steady-state trajectory of m, mₐ₀ is a steady-state trajectory of mₐ, m_{b0} is a steady-state trajectory of m_{b}, m_{c0} is a steady-state trajectory of m_{c}, Δmₐ is a small signal perturbation of mₐ, Δm_{b} is a small signal perturbation of m_{b}, and Δm_{c} is a small signal perturbation of m_{c}.

The steady-state trajectory x₀ of the nonlinear model of a three-level inverter is specifically shown as follows:

$${x}_{0} = [ \begin{matrix}{i}_{m 0} & {m}_{0} & {m}_{pn 0} & {θ}_{0} & {φ}_{0} & {sgn ( {m}_{j} )}_{0}\end{matrix} ]$$

The main features of performing linearization processing on the nonlinear model of a three-level inverter, thereby constructing the linear time-periodic model of a three-level inverter considering neutral point dynamics comprise:

$$\{ \begin{matrix}Δ {\dot{u}}_{pn} = \frac{Δ {i}_{pn}}{{C}_{p} + {C}_{n}} \\ Δ \text{?} = \text{?} ( 0 - Δ {u}_{pn} ) \\ Δ \text{?} = \frac{( \text{?} ( 0 - Δ {u}_{pn} ) + {x}_{v} )}{\text{?}} \\ \begin{matrix}\text{?} = \text{?} [ - Δ sgn \text{?} + ( 1 - sgn \text{?} ] - 6 / π ( \text{?} cos \text{?} Δ \text{?} + \\ \text{?} cos \text{?} Δ \text{?} Δ φ\end{matrix} \\ Δ sgn ( \text{?} ) = \{ \begin{matrix}0 , \text{?} + Δ \text{?} > 0 \\ \text{?} {sech}^{2} ( 0 ) Δ \text{?} , \text{?} + Δ \text{?} = 0 \\ 0 , \text{?} + Δ \text{?} < 0\end{matrix} \\ Δ sgn ( \text{?} ) = \{ \begin{matrix}0 , \text{?} + Δ \text{?} > 0 \\ \text{?} {sech}^{2} ( 0 ) Δ \text{?} , \text{?} + Δ \text{?} = 0 \\ 0 , \text{?} + Δ \text{?} < 0\end{matrix} \\ Δ sgn ( \text{?} ) = \{ \begin{matrix}0 , \text{?} + Δ \text{?} > 0 \\ \text{?} {sech}^{2} ( 0 ) Δ \text{?} , \text{?} Δ \text{?} = 0 \\ 0 , \text{?} + Δ \text{?} < 0\end{matrix} \\ Δ \text{?} = - Δ m cos ( {θ}_{0} - {φ}_{0} ) + {m}_{0} cos ( {θ}_{0} - {φ}_{0} ) ( Δ θ - Δφ ) \\ Δ \text{?} = - Δ m cos ( {θ}_{0} - {φ}_{0} - 2 π / 3 ) + \text{?} cos ( {θ}_{0} - {φ}_{0} - 2 π / 3 ) ( Δθ - Δφ ) \\ Δ \text{?} = - Δ m cos ( {θ}_{0} - {φ}_{0} + 2 π / 3 ) + \text{?} cos ( {θ}_{0} - {φ}_{0} + 2 π / 3 ) ( Δθ - Δφ )\end{matrix}$$

$$\text{?} \text{indicates text missing or illegible when filed}$$

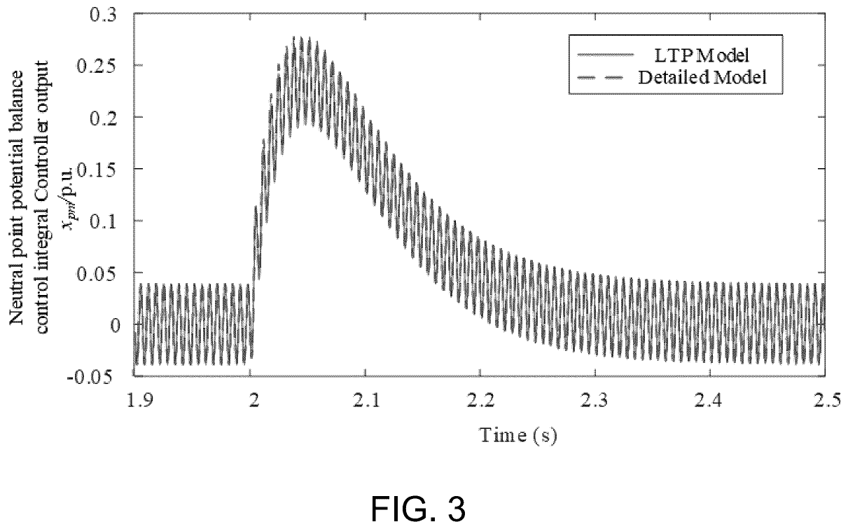

The linear time-periodic model of a three-level inverter is established based on the Matlab/Simulink simulation software platform. When the system operates in a rated state for 2 seconds, a disturbance perturbation (a 5% reduction in a voltage reference value) is given to the system to obtain a time-domain dynamic response of the proposed linear time-periodic model of a three-level inverter. The time-domain dynamic response of the linear time-periodic model (LTP Model) of a three-level inverter is superimposed with the steady-state trajectory. The comparison with a neutral point voltage dynamic process of the original nonlinear model of a three-level inverter is shown in FIG. 3. It can be seen that after being disturbed, the neutral point voltage of the inverter oscillates and decays rapidly, and the system returns to stability after 0.5 seconds. By comparing the simulation results of the original nonlinear model of a three-level inverter with the calculation results of the proposed linear time-periodic model of a three-level inverter, it can be known that the linear time-periodic model of a three-level inverter proposed in the embodiments of the present application can accurately reflect neutral point dynamics under a small signal in the original nonlinear model.

The following describes a method for constructing the linear time-periodic model of a three-level inverter considering neutral point dynamics provided in the present application. The method for constructing the linear time-periodic model of a three-level inverter considering neutral point dynamics described below can be executed by the linear time-periodic model of a three-level inverter considering neutral point dynamics described above.

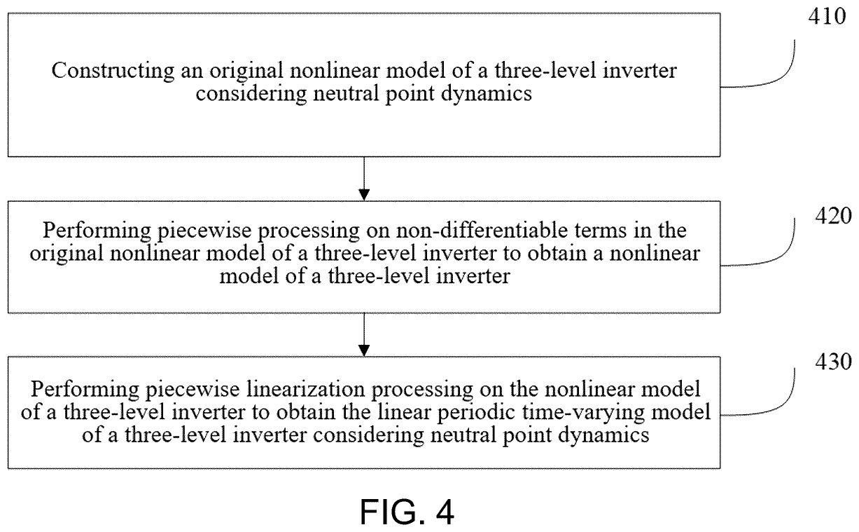

Referring to FIG. 4, the embodiments of the present application provide a method for constructing the linear time-periodic model of a three-level inverter considering neutral point dynamics, comprising: step 410, step 420 and step 430.

Step 410: constructing an original nonlinear model of a three-level inverter considering neutral point dynamics;

Step 420: performing piecewise linearization processing on non-differentiable terms in the original nonlinear model of a three-level inverter to obtain a nonlinear model of a three-level inverter;

Step 430: performing piecewise linearization processing on the nonlinear model of a three-level inverter to obtain the linear time-periodic model of a three-level inverter considering neutral point dynamics.

In method for constructing the linear time-periodic model of a three-level inverter considering neutral point dynamics provided by the embodiments of the present application, a piecewise linearization processing method is adopted to divide non-differentiable terms in an original nonlinear model of a three-level inverter into a plurality of linear segments, and linearization processing is carried out in each segment to eliminate the non-differentiable terms of a non-differentiable part (such as a neutral point voltage and a neutral point current) and ensure that the linear time-periodic model of a three-level inverter obtained is locally analyzable, which avoids the problem of difficulty in overall linearization. The linear time-periodic model of a three-level inverter is generated by combining with a steady-state trajectory, which can comprehensively reflect small signal characteristics of a three-level inverter. In particular, the model generated can precisely describe dynamic characteristics of a neutral point of the three-level inverter under a small signal, effectively depict behaviors of the three-level inverter under minor disturbances, and can be applied to small signal stability analysis of a power system containing the three-level inverter.

It can be understood that the detailed function implementation of each of the above units/modules can be referred to the introduction in the foregoing method embodiments, and will not be repeated here.

It should be understood that the above device is configured to execute the method in the above embodiments. Corresponding program modules in the device have implementation principle and technical effect similar to those described in the above method. A working process of the device can be referred to a corresponding process in the above method, and will not be repeated here.

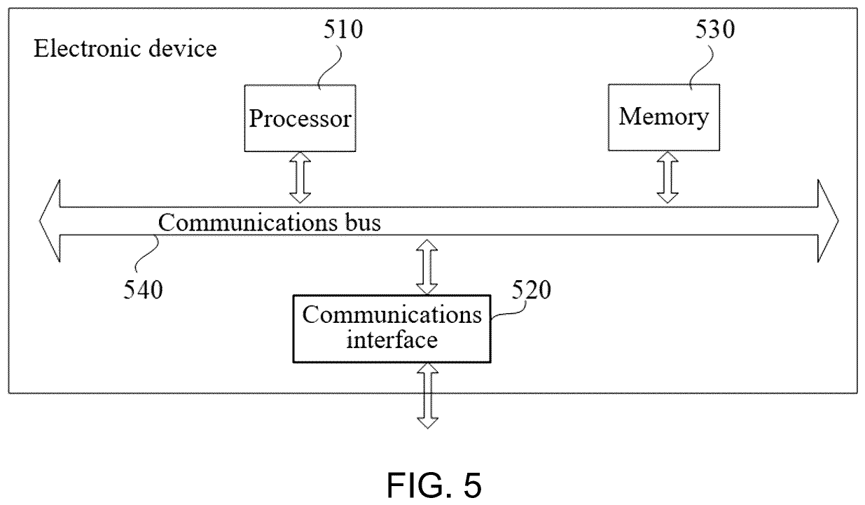

Based on the method in the above embodiments, the embodiments of the present application provide an electronic device, referring to FIG. 5, and the electronic device can comprise: a processor 510, a communications interface 520, a memory 530 and a communications bus 540, wherein the processor 510, the communications interface 520 and the memory 530 complete mutual communication through the communications bus 540. The processor 510 can invoke logic instructions in the memory 530 to execute the method described in the above embodiments.

In addition, if implemented in the form of a software function unit and sold or used as an independent product, the logic instruction in the memory 530 can be stored in a computer readable storage medium. Based on such understanding, the technical solutions of the present application can be reflected in the form of a software product in essence or in a part of making a contribution to the prior art. The computer software product is stored in a storage medium, comprising several instructions to enable one computer device (which may be a personal computer, a server or a network device) to execute all or some steps of the methods of various embodiments of the present application.

Based on the method in the above embodiments, the embodiments of the present application provide a computer readable storage medium storing a computer program which, when executed on a processor, makes the processor execute the method in the above embodiments.

Based on the method in the above embodiments, the embodiments of the present application provide a computer program product which, when executed on a processor, makes the processor execute the method in the above embodiments.

It can be understood that the processor in the embodiments of the present application can be a central processing unit (CPU), other general-purpose processors, a digital signal processor (DSP), an application specific integrated circuit (ASIC), a field programmable gate array (FPGA), other programmable logic devices, transistor logic devices, hardware components or any combination thereof. The general-purpose processor may be a microprocessor or any conventional processor.

The steps of the method in the embodiments of the present application can be implemented either by software or by a processor executing software instructions. The software instructions can be composed of corresponding software modules, and the software modules can be stored in a random access memory (RAM), a flash memory, a read-only memory (ROM), a programmable ROM (PROM), an erasable PROM (EPROM), an electrically EPROM (EEPROM), a register, a hard disk, a mobile hard disk, a CD-ROM or any other form of storage medium well known in the art. An exemplary storage medium is coupled to the processor so that the processor can read information from and write information to the storage medium. Of course, the storage medium can also be a component of the processor. The processor and the storage medium can be located in ASIC.

The above embodiments can be realized by software, hardware, firmware or any combination thereof in whole or in part. When realized by software, the above embodiments can be realized in the form of a computer program product in whole or in part. The computer program product comprises one or more computer instructions. When loaded and executed on a computer, the computer program instructions generate a process or function as described in the embodiments of the present application in whole or in part. The computer can be a general-purpose computer, a special-purpose computer, a computer network or other programmable devices. The computer instructions can be stored in the computer readable storage medium or transmitted through the computer readable storage medium. The computer instructions can be transmitted from one website, computer, server or data center to another website, computer, server or data center by wired (such as coaxial cables, optical fibers and digital subscriber lines (DSLs)) or wireless (such as infrared, wireless and microwave) methods. The computer readable storage medium may be any available medium which can be accessed by a computer or a data storage device, such as a server and a data center, containing one or more integrated available media. The available medium may be a magnetic medium (such as a floppy disk, a hard disk and a magnetic tape), an optical medium (such as DVD), or a semiconductor medium (such as a solid state disk (SSD)).

It can be understood that various numerical symbols involved in the embodiments of the present application are for distinction only for the convenience of description and are not intended to limit the scope of the embodiments of the present application.

It is easily understood by those skilled in the art that the above only describes preferred embodiments of the present application and is not intended to limit the present application. Any modification, equivalent replacement, improvement, etc. made within the spirit and the principle of the present application shall be contained within the protection scope of the present application.

What is claimed is:

1. A linear time-periodic model of a three-level inverter considering neutral point dynamics, comprising:
a construction module, configured to construct an original nonlinear model of a three-level inverter considering neutral point dynamics;
a first processing module, configured to perform piecewise processing on non-differentiable terms in the original nonlinear model of a three-level inverter to obtain a nonlinear model of a three-level inverter; and
a second processing module, configured to perform piecewise linearization processing on the nonlinear model of a three-level inverter to obtain the linear time-periodic model of a three-level inverter considering neutral point dynamics.

2. The linear time-periodic model of a three-level inverter considering neutral point dynamics according to claim 1, wherein the original nonlinear model of a three-level inverter comprises:
an external circuit dynamic module, a power outer loop controller, a current inner loop controller, a phase-locked loop controller, an internal circuit dynamic module and a neutral point potential balance controller;
the external circuit dynamic module is configured to send an output current and a grid interconnection voltage of a three-level inverter to the phase-locked loop controller, the power outer loop controller and the current inner loop controller, and send the output current, a power factor angle and an amplitude of the output current to the internal circuit dynamic module;
the phase-locked loop controller is configured to determine a phase-locked angle based on the output current and the grid interconnection voltage, and send the phase-locked angle to the internal circuit dynamic module, the current inner loop controller and the power outer loop controller respectively;
the power outer loop controller is configured to generate a reference current based on the phase-locked angle, the grid interconnection voltage and the output current, and send the reference current to the current inner loop controller;
the current inner loop controller is configured to generate a modulated wave based on the phase-locked angle, the reference current and the output current, and send the modulated wave to the internal circuit dynamic module;
the internal circuit dynamic module is configured to determine a neutral point current of the three-level inverter and a neutral point voltage of the three-level inverter based on an output value of the neutral point potential balance controller, the phase-locked angle, the output current and the modulated wave;
the neutral point potential balance controller is configured to determine the output value based on the neutral point voltage.

3. The linear time-periodic model of a three-level inverter considering neutral point dynamics according to claim 2, wherein the first processing module is further configured to:
perform piecewise processing on non-differentiable terms in the neutral point current and the neutral point voltage to obtain the nonlinear model of a three-level inverter.

4. The linear time-periodic model of a three-level inverter considering neutral point dynamics according to claim 2, wherein the neutral point potential balance controller adopts a proportional-integral controller.

5. The linear time-periodic model of a three-level inverter considering neutral point dynamics according to claim 1, wherein the second processing module is further configured to:
determine a steady-state trajectory of the nonlinear model of a three-level inverter when operating to a steady-state condition.

6. The linear time-periodic model of a three-level inverter considering neutral point dynamics according to claim 1, wherein the three-level inverter is a neutral point clamped three-level inverter or a T-type three-level inverter.

7. A method for constructing the linear time-periodic model of a three-level inverter considering neutral point dynamics, comprising:
constructing an original nonlinear model of a three-level inverter considering neutral point dynamics;
performing piecewise processing on non-differentiable terms in the original nonlinear model of a three-level inverter to obtain a nonlinear model of a three-level inverter; and
performing piecewise linearization processing on the nonlinear model of a three-level inverter to obtain the linear time-periodic model of a three-level inverter considering neutral point dynamics.

8. An electronic device, comprising:
at least one memory, configured to store computer programs; and
at least one processor, configured to execute programs stored in the memory, and configured to implement the method according to claim 7 when the programs stored in the memory are executed.

9. A computer readable storage medium storing computer programs, wherein the computer programs, when executed on a processor, make the processor execute the method according to claim 7.

10. A computer program product, wherein the computer program product, when executed on a processor, makes the processor execute the method according to claim 7.
